(19) United States
(12) Patent Application Publication
(10) Pub. No.: US 2007/0041729 A1
(43) Pub. Date: Feb. 22, 2007

(54) Systems and methods for detecting changes in incident optical radiation at high frequencies

(76) Inventors: Philip Heinz, Huntington, NY (US); Elsa Garmire, Hanover, NH (US)

Correspondence Address: LATHROP & GAGE LC, 4845 PEARL EAST CIRCLE, SUITE 300, BOULDER, CO, 80301, US

(21) Appl. No.: 11/413,463

(22) Filed: Apr. 28, 2006

Related U.S. Application Data
(63) Continuation-in-part of application No. 10/532,453, filed on Apr. 22, 2005.
(60) Provisional application No. 60/420,623, filed on Oct. 23, 2002.
(60) Provisional application No. 60/675,568, filed on Apr. 28, 2005.

(51) Int. Cl. H04B 10/08

(52) U.S. Cl. 398/25; 370/238

(57) ABSTRACT

Systems and methods detect changes in incident optical radiation at high frequencies. A detector having one or more asymmetrically conductive areas, formed of relaxation semiconductor material, is configured with at least two electrical contacts, positioned on opposite sides of an active area. Asymmetrical conductivity, for example provided by use of one doped contact and one un-doped contact, creates a transient voltage across the active area, which is measured by electronics connected with the electrical contacts. The transient voltage indicates changes in incident optical radiation, which may be distributed spatially uniformly over the system.

### RELATED APPLICATIONS

This application is a continuation-in-part of U.S. Ser. No. 10/532,453, filed 22 Apr. 2005, which is the U.S. national stage entry of PCT/US03/33522, which claims priority to provisional application Ser. No. 60/420,623, filed 23 Oct. 2002. This application also claims priority to provisional application Ser. No. 60/675,568, filed 28 Apr. 2005. Each of these applications is incorporated herein by reference.

### BACKGROUND

Examining surface displacement (e.g., vibration) of an object or surface with optical radiation has advantages in many settings, for example in high-temperature or vacuum conditions where physical contact with the object or surface could easily damage expensive equipment or disrupt the desired vacuum conditions. In another example, it is advantageous to perform contactless, nondestructive testing of structural members or mechanical components, for example for ultrasonic movement of the members or components, or to search for defects. Among various techniques proposed to exploit these advantages, techniques that employ the Fabry-Perot interferometer, the photo-emf effect or photorefractive crystals appear most promising, largely due to their ability to detect nanometer-scale vibrations of rough surfaces in the presence of speckle (when a surface under investigation is optically rough, laser illumination of the surface and collection of backscatter results in speckle). Nonetheless, each of these techniques also requires “referencing,” which utilizes signal and reference beams from the same wavefronts during direct interferometric detection; for practical applications, this referencing requires additional optical components that often misalign while detecting intensity changes or speckle patterns in the optical radiation, particularly in the presence of mechanical vibration or movement. Misalignment may cause critical failures, because altering the angular relationship between signal and reference beams also changes the grating spacing on the detector. Prior art techniques (for example utilizing the photo-emf effect) are very sensitive to operating at precisely the right grating spacing.

Prior art devices that measure speckle patterns or changes in incidental optical radiation also utilize the power in the optical radiation to drive the output signal. Such devices are problematic because, for example, the power available to these devices is dependant on the detecting area; the electronic output depends on the detecting area so that scaling the device to smaller size results in lower output. Among other drawbacks, this impedes vibration detection since the detecting area must be smaller than the speckle size to avoid signal attenuation and to avoid averaging of variations across the sensing element.

Prior art optical detectors are also problematic whenever a small detecting area is needed and the intensity of the optical radiation is weak. For example, in such situations, photodiodes and photodiode arrays generate very small currents, from micro-amps to nano-amps, that are very hard to measure; they also generate signals that are significantly impacted by noise and interference.

### SUMMARY OF THE INVENTION

Certain systems and methods described herein may advantageously improve frequency response and measurement of asymmetrical illumination in detectors fabricated from relaxation semiconductor materials. Such systems and methods may also detect changes in incident intensity without an externally supplied current or bias, thus reducing power consumption.

In one embodiment, a system for detecting changes in incident optical radiation at high frequencies includes a detector having one or more active areas formed of relaxation semiconductor material, and at least two electrical contacts positioned with an active area therebetween. Electronics connected to the electrical contacts sense a transient voltage across at least one of the active areas, the transient voltage being indicative of the changes in incident optical radiation.

In one embodiment, a method for detecting changes in incident optical radiation at high frequencies includes: providing a detector with one or more asymmetrically conductive active areas formed of relaxation semiconductor material and at least two electrical contacts on opposite sides of an active area; connecting electronics to the electrical contacts; exposing the detector to illumination; and sensing a transient voltage across the active area, the transient voltage being indicative of the changes in incident optical radiation.

In one embodiment, a system for detecting changes in a spatially uniform intensity distribution incident on the system includes one or more volumes of photoconductive material, at least one doped electrical contact and at least one un-doped electrical contact. One or more conductive paths connect the electrical contacts to the volumes of photoconductive material so as to form a series circuit, with the volumes of photoconductive material located between the electrical contacts. Electronics determine a transient voltage across one or more of the volumes of photoconductive materials, a change in voltage being indicative of a change in the optical intensity distribution.

In one embodiment, a system for detecting changes in incident optical radiation at high frequencies includes a detector with one or more active areas of an increased dark conductivity, and a source for applying current through the active areas. First electrical contacts inject the applied current. Electronics connected to second electrical contacts determine voltage drop across at least one of the active areas, the voltage drop being indicative of the changes in incident optical radiation.

In one embodiment, a system for detecting changes in incident optical radiation at high frequencies includes a detector having one or more active areas of an increased average photoconductivity; a source for applying current through the active areas; first electrical contacts for injecting the applied current; second electrical contacts; and electronics connected to the second electrical contacts, for determining voltage drop across at least one of the active areas, the voltage drop being indicative of the changes in incident optical radiation.

In one embodiment, a method for detecting changes in incident optical radiation at high frequencies includes: increasing an average conductivity of a detector; driving current through one or more active areas of the detector while the incident optical radiation illuminates the active areas; and sensing voltage across one or more of the active areas, a change in the voltage being indicative of the changes in incident optical radiation.

In one embodiment, a system for detecting changes in incident optical radiation, includes: a detector having one or more active areas formed of relaxation semiconductor material and having asymmetrical conductivity; a source for applying current through the active areas; first electrical contacts for injecting the applied current; second electrical contacts; and electronics connected to the second electrical contacts, for determining voltage drop across at least one of the active areas, the voltage drop being indicative of the changes in incident optical radiation.

### BRIEF DESCRIPTION OF THE DRAWINGS

FIG. 1 illustrates one system for detecting changes in incident optical radiation at high frequencies.

FIG. 2 shows an illustrative illumination set-up to that generates incident optical radiation with time-varying intensity.

FIG. 3A shows a schematic illustration of one system for detecting changes in incident optical radiation.

FIG. 3B illustrates another embodied system for determining changes in incident optical radiation.

FIG. 4 graphically shows the signal output from one experimental system for detecting changes in incident optical radiation at high frequencies, indicating detection of a lateral speckle pattern displacement.

FIG. 5 graphically shows the signal output from the experimental system of FIG. 4, indicating detection from an electro-optic modulator operating at one megahertz.

FIG. 6A shows a flow chart of one process of detecting changes in incident optical radiation at high frequencies.

FIG. 6B is a flow chart of a process for detecting changes in incident optical radiation at high frequencies.

FIG. 6C provides a flow chart of another process for detecting changes in incident optical radiation at high frequencies.

FIG. 7 and FIG. 7A illustrate exemplary arrangement of electrodes and active area for a detector electrically connected as in FIG. 1.

FIG. 8 shows an illustrative illumination arrangement using a multimode optical fiber, to monitor an object with a detector.

FIG. 9 shows one multimode fiber optic sensor.

FIG. 10 schematically illustrates one illustrative method of alignment using a periodic mask and a detector.

FIG. 11 shows one three-dimensional optical radiation detector.

### DETAILED DESCRIPTION OF ILLUSTRATED EMBODIMENTS

In one embodiment, an optical sensor has a detector made of photoconductive material; the photoconductive material's photoconductivity depends on the intensity of the incident optical radiation. The sensor may employ one of three alternative methods to measure change in the intensity: in the first method, the sensor injects a constant current to the detector and measures the change in voltage drop across one or more active areas of the photoconductive material; in the second method, the sensor applies a constant voltage across the detector so that one or more active areas of the detector form a voltage divider, wherein the distribution of voltage drops across the active areas then depends on illumination by the incident optical radiation. The second method may also employ a fixed resistance connected in series with the active areas, to form the voltage divider. In the third method, the applied voltage or current is modulated by a square wave or other waveform (e.g., a periodic modulation such as a sine wave). Selective amplification at the frequency of the modulation may help to achieve higher signal-to-noise ratios.

The optical sensor may be used to detect vibrations and surface displacements by observing the changes in interference or speckle patterns due to surface motion (e.g., continuous or transient surface motion with amplitudes of the order of nanometers, or higher). This detection is for example useful to assess mechanical resonances and ultrasonic waves associated with non-destructive testing. When the detector has an array of active areas, as opposed to a single point detector element, signal processing electronics may average the output of the individual active areas to provide a large and observable signal, without the need for nonlinear phase-compensating elements of the prior art. Accordingly, laser light scattered off an optically rough surface forms the speckle pattern that reconfigures and/or moves laterally as the surface displaces, either due to a mechanical resonance or due to an ultrasonic wave. As the speckle pattern moves, local variations in optical intensity are detected by the optical sensor.

Certain advantages may be realized by the optical sensor. First, an external current or voltage source powers the detector, which then uses optical power from the incident radiation to modulate the constant current with information content. The incident optical radiation is therefore not used as the power source to drive the signal, as in certain devices of the prior art. The same advantage is obtained when using the detector with a voltage source. Second, the optical sensor may be scaled to small size (e.g., in the micrometer range) since the photoconductivity of the photoconductive material depends on the detector's aspect ratio rather than on total surface area. This allows for detection over a single speckle, making it possible to reduce dimensions of the optical arrangement illuminating the surface to a portable unit (e.g., a unit employing optical fiber). Third, by using the four-point measurement, a voltage output is produced that is compatible with observation instruments such as an electronic scope or spectrum analyzer. The voltage output is for example millivolts, compared to nanoamps to microamps generated by photodiodes used in comparable applications.

The optical sensor may have various applications, and may be conveniently employed with known systems that generate ultrasonic waves in objects. By way of example, it may be used with laser-based ultrasound to measure sample thicknesses or to detect defects. In this example, a pulse laser generates a high-power pulse (e.g., a pulse with megawatts of power and with nanoseconds of illumination) on the surface of the sample to generate ultrasonic waves in the sample. A separate detection laser (e.g., a HeNe laser) then illuminates the sample and the optical sensor detects changes in optical radiation reflected off of the surface. In another example, piezoelectric transducers generate the ultrasonic waves in the object; the detection laser and optical sensor are then used to non-destructively test the object (e.g., for defects or object thickness).

The optical sensor may also be used within manufacturing (e.g., for quality assurance issues), for example, or within transportation (e.g., for safety issues). Non-destructive testing in manufacturing, for example, enables quality control by detecting defects (e.g., cracks and inclusions in finished products). Another application for the optical sensor is within metal processing, where continuity checks of thin sheet goods can be made by detecting Lamb waves. Yet another application for the optical sensor is the determination of how many balls are in a bearing. In transportation, the optical sensor may be deployed in the detection of cracks, inclusions or other defects in solid objects, such as railroad tracks, wheels, axles, wings, hulls or other components of trains, cars, trucks, ships or aircraft. In civil engineering, the optical sensor may be employed in integrity tests of steel girders, bridges, or similar structural components. Misalignments due to earthquakes, ground shifting or structural weaknesses can also be monitored through use of the optical sensor. In medical applications, the optical sensor may be deployed, for example, in the detection of cavities in teeth.

In addition to ultrasonic testing, the optical sensor may be used at lower frequencies, to measure vibrations (e.g., audible or sub-sonic vibrations). For example, the optical sensor may enhance security applications by remotely monitoring conversations through vibrating windows of a building or by determining whether activity exists within a vehicle through vibrations of the vehicle.

Because the detector of the optical sensor may be scaled in size to be compatible with multi- and single-mode optical fibers, the optical sensor may also be used when illumination is provided by fibers. Accordingly, when vibration of a surface hidden from view needs to be monitored, the detector and optical fibers may be disposed in hard to reach locations that heretofore were inaccessible. In one example, detection of cavities in teeth may require fiber illumination.

Fibers may also be employed within certain communications systems, and so the optical sensor may have application within communications. For example, by placing the active area of the detector onto an optical fiber, with its area matched to that of a single mode fiber, changes in optical radiation from the fiber may be detected. If the detector employs an array of active areas, the optical sensor may also be employed with fiber arrays, for LED-driven parallel systems. An optical sensor employing the arrayed detector may also be used to sense higher-order Gaussian beams in free-space communications systems.

The detector may employ a two-dimensional array of active areas, to facilitate optical imaging. In one example, the arrayed detector may be used as a type of spatial filter, for example to facilitate precision alignment of machinery. Other arrayed detectors may be used in tracking, as a navigation aid for ships, aircraft, or missiles, or as a motion sensor, detecting, for example, intruders.

In measurements of vibration, the optical sensor may be used in a “referenceless” configuration, since it does not require direct interferometric detection. It may also operate without significant optical alignment. These benefits occur because the optical detector can be made very small and used with an array of active areas; the optical sensor lends itself to use in referenceless experimental setups that do not depend on direct interferometric detection.

In one embodiment, a method detects changes in incident optical radiation. Current is driven through one or more active areas of a detector while the incident optical radiation illuminates the active areas. Voltage is sensed across one or more of the active areas, a change in the voltage being indicative of the changes in incident optical radiation.

In another embodiment, a method determines surface motion, including: illuminating a surface with a laser having a wavelength that is smaller than defined geometric features of the surface; and detecting moving speckle indicative of surface motion by: driving current through one or more active areas of a detector while the moving speckle illuminates the active areas; sensing voltage across one or more of the active areas to detect the surface motion.

In one embodiment, a method determines surface motion, including: generating an interference pattern that varies with surface motion; and detecting the interference pattern by: driving current through one or more active areas of a detector while the interference pattern illuminates the active areas; and sensing voltage across one or more of the active areas to detect the surface motion.

In one embodiment, a sensor detects changes in incident optical radiation. A detector has one or more active areas formed of photoconductive material. A source applies current through the active areas. Electronics determine voltage drop across at least one of the areas, the voltage drop being indicative of the changes in incident optical radiation.

In one embodiment, an optical radiation detector is provided. The detector has photoconductive material forming one or more active areas. Input electrodes provide for connection to a source, to drive current through the active areas. Output electrodes provide for connection to an observation instrument, to sense voltage drop across one or more of the active areas.

In one embodiment, a method aligns two objects, including: generating an interference pattern dependent upon a distance between the two objects; and sensing changes in the interference pattern to achieve optimal alignment between the objects by: driving current through one or more active areas of a detector while the interference pattern illuminates the active areas; and sensing voltage across one or more of the active areas, a change in the voltage being indicative of a change in the distance between the objects.

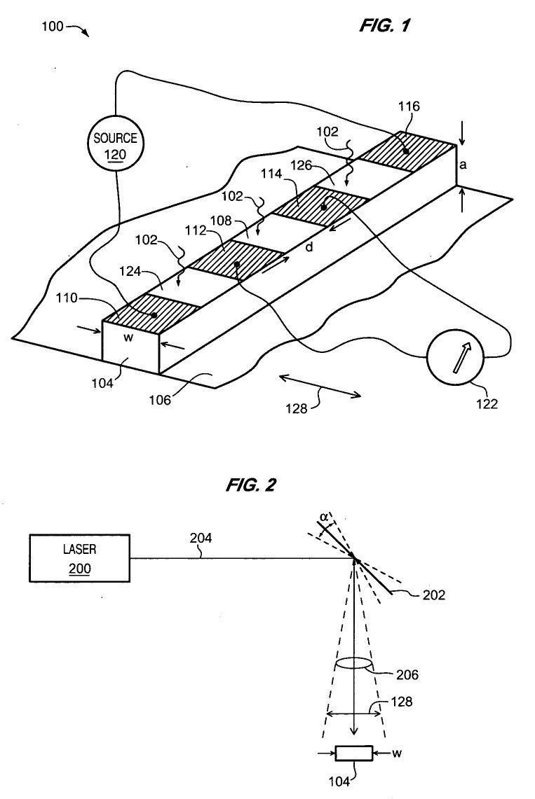

FIG. 1 shows a system 100, for example an optical sensor 100 that detects intensity changes in optical radiation 102 incident on its detector 104, through a four-point measurement where current is for example sourced and sunk through two contacts, and a voltage drop is observed across an area formed by two additional contacts. Detector 104 is formed (e.g., etched) from a photoconductive substrate 106 and includes one or more photosensitive regions (active areas) 108, and an array of connectivity points (also referred to as electrodes, or electrical contacts) 110, 112, 114, 116.

Additional active areas may be formed by adding additional contacts between the current source/sink contacts. One exemplary optical sensor employs four active areas fabricated with semi-insulating gallium arsenide (GaAs), though other detector materials may be employed.

A source 120 connects to outer two connectivity points 110, 116, to power detector 104; and an observation instrument 122 measures voltage across two inner connectivity points 112, 114, as shown. Inner connectivity points 112, 114 form an active area 108 therebetween, and are for example collinear with the current source/sink contacts 110, 116. Source 120 is for example a direct current source, a voltage source, or a source that applies time-varying current or voltage to detector 104. Observation instrument 122 is for example an electronic oscilloscope that monitors a resulting time-varying voltage signal from inner connectivity points 112, 114, indicating time-varying change of intensity in incident radiation 102 on active area 108. By analyzing this time-varying signal on a frequency basis (e.g., through use of a spectrum analyzer as observation instrument 122), frequency-dominant voltage signals may be isolated to indicate modulation of the incident optical radiation 102 (for example caused by vibrating surfaces interacting with or reflecting optical radiation 102 at ultrasonic frequencies).

In one embodiment, active areas 108 are formed from relaxation semiconductor material such as semi-insulating gallium arsenide (GaAs), though other detector materials may be employed. However, unlike prior art detectors fabricated from relaxation semiconductor material, detector 104 may provide enhanced operation at high frequencies due to an increase in average photoconductivity.

In general, prior art detectors fabricated from relaxation semiconductor materials (e.g., semi-insulating GaAs or other semi-insulating materials), where the charge carrier lifetime is shorter than the dielectric relaxation time), are limited in frequency response due to the relaxation of space-charge. The time constant associated with this relaxation process is typically of the order of the dielectric relaxation time, defined as the ratio of dielectric permittivity to average conductivity. At low incident intensity levels (less than mW/cm2), the detector response is therefore typically limited to the kilohertz range in these materials. However, the average conductivity of detector 104 is increased by increasing one or both of dark conductivity and photoconductivity, thereby providing enhanced operation at high frequencies.

Dark conductivity of detector 104 is for example increased by fabricating detector 104 from one or more materials with a larger dark carrier concentration, and/or one or more materials having a carrier lifetime that is longer than the dielectric relaxation time. Additionally or optionally, dark conductivity of detector 104 is increased by selectively doping shadowed regions underneath electrical contacts 110, 112, 114, 116. Photoconductivity of detector 104 may be increased by using higher levels of incident intensity or by reducing device dimensions such that the width of contacts 110, 112, 114, 116 is comparable to the detector 104 material's diffusion length, thus increasing average conductivity beneath the contacts by diffusion. Likewise, average conductivity underneath contacts 110, 112, 114, 116 (and thus photoconductivity of detector 104) may be increased by using transparent contacts 110, 112, 114, 116.

Detector 104 is also shown with active areas 124 and 126. Active areas 124, 126 may be used in the four-point measurement, but not to detect radiation 102 for detector 104. If detector 104 were made without active areas 124, 126 (that is, active areas 124, 126 were not present), the injected current to detector 104 would flow through electrodes 112, 114, used for the four-point measurement; and the four-point measurement would instead depend on the physical characteristics of electrodes 112, 114. With the four-point measurement as in FIG. 1, current does not flow through electrodes 112, 114, so such measurement is independent of contact characteristics. This is useful because it is frequently difficult to form high-quality contacts on many materials. Accordingly, active areas 124, 126 are not used as actual sensing elements for detector 104 in the configuration of FIG. 1. Upon reading and fully comprehending this disclosure, those skilled in the art thus appreciate that active areas 124, 126 may be formed of semiconducting (e.g., semi-insulating GaAs) or resistive material to provide like function (i.e., to provide current flow through active area 108, from source 120). Moreover, if contacts 110, 112, 114, 116 have sufficiently high quality, it is possible that detector 104 functions in like manner without active areas 124, 126 (that is, contacts 110, 112 are adjacent one another and not spaced apart by active area 124, and contacts 114, 116 are adjacent one another and not spaced apart by active area 126).

If source 120 is a constant voltage source, then the voltage drop across active areas 124, 126 may be taken into account. Specifically, if illumination of active area 108 changes, the voltage drop will change if there is a differing intensity change incident on active areas 124, 126 as compared to active area 108. Accordingly, there may be a situation where detection is nullified, though rare in occurrence. For example, if active areas 124, 126 are “dark” (not illuminated), the voltage drop across active area 108 accurately detects changes in incident optical radiation 102. Accordingly, in one embodiment, a mask (not shown) covers active areas 124, 126 such that they are dark, but the dimensions of areas 124, 126 are chosen such that they still carry current from source electrode 110 to drain electrode 116. Preferably, the dark conductivity of regions 124, 126 is high enough that they are not highly resistive. Active areas 124, 126 may also be made kept very thin to enable current flow through relatively high resistivity material. This will also reduce problems associated with illumination of regions 124, 126. Keeping active areas 124, 126 in the dark by a mask or other means may thus depend upon the material and geometry used to provide one solution ensuring a variation in voltage drop across active area 108 is proportional to its illumination.

As intensity of incident radiation 12 varies, the photoconductance S of material between connectivity points 112, 114 is determinable. As in Equation 1 below, photoconductance S depends on the active area's aspect ratio (width w divided by length d) for a given absorption depth a, such that detector 104 may be scaled down to the desired small size without loss of signal:

$$S = σ a \frac{w}{d} \qquad ( Equation 1 )$$

σ stands for conductivity, which depends on the carrier concentration generated by incident optical radiation 102. The carrier concentration depends on the intensity of incident radiation 102, rather than the total power absorbed, so that photosensitive regions 124, 108, 126 may be sized to fit within a desired grating spacing (or to some other desired dimension, such as to correspond to speckle size). The arrangement of electrodes 110, 112, 114, 116 may be chosen so as to prevent diffusion of charge carriers out of detector 104. This can be achieved, for example, by selecting width w to be typically at most one diffusion length wide (dimension w), while depth a is typically at least one diffusion length deep (dimension a). This ensures that photogenerated charge carriers will recombine before they can contribute to conductivity outside the region of interest.

With regard to active areas 124, 126, width w and length d need not be the same as active area 108. In one embodiment, for example, width w and length d for active areas 124, 126 are chosen (e.g., via doping density of the photoconductive material) so that current flows through active area 108, but also such that there is no short-circuit between electrodes 110, 112 and 114, 116, respectively.

The photoconductive area forming active area 108 is for example a semiconductor. For example, the photoconductive material may comprise either a III-V semiconductor or a II-VI semiconductor. A III-V semiconductor is defined by one or more components of the composition from the III column of the periodic table, and one or more components of the composition from the V column. A II-VI semiconductor is defined by one or more components of the composition from the II column of the periodic table, and one or more components of the composition from the VI column.

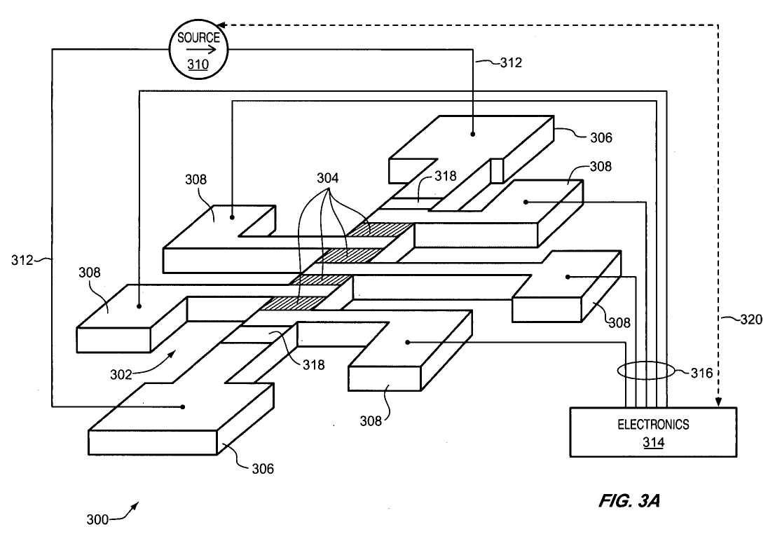

Note that the variation of intensity in incident optical radiation 102 may occur through cyclical (e.g., periodic) motion of optical radiation 102 back and forth across detector 104, along a direction 128, and typically at one or more dominant frequencies. The variation in intensity may also occur through transient motion of optical radiation 102 across detector 105, along direction 128. Direction 128 is shown illustratively; however the cyclical or transient motion of optical radiation 102 may occur in any orientation relative to detector 104. FIG. 2 illustratively shows how the cyclical or transient motion may occur. A laser 200 illuminates a surface 202 (with a laser beam 204) that tilts through an angle α (or that displaces parallel or perpendicular to surface 202) due to vibration or transient displacement of surface 202; this vibration typically occurs with peak energies at resonant or dominant frequencies. Backscattered radiation 206 from laser beam 204 illuminates detector 104 with a time-varying intensity pattern along direction 128 (also at the dominant frequencies, in the case of cyclical motion of optical radiation 102 back and forth across detector 104). Backscattered radiation 206 may include speckle when surface 202 is optically rough in comparison to the wavelength of laser beam 204 (that is, the wavelength is much smaller than defined geometric features of surface 202). If surface area wd of active area 108 corresponds in size to an average speckle, then one active area 108 may detect that speckle. Laser 200 is for example an Argon laser emitting a laser beam 204 at about 488 nm.

By sensing voltage drop across active area 108, sensor 102 produces time-varying voltage that may be analyzed in the time domain or in the frequency domain. Accordingly, it should therefore be clear that detector 104 monitors both periodic and transient motion of optical radiation 102 across detector 104 (for example, along direction 128). Periodic motion may relate to resonant behavior (e.g., vibration) of a surface which reflects radiation 102 to detector 104, for example, while transient motion may for example relate to ultrasonic testing. Hereinafter, periodic and transient motions may be collectively denoted as “motion.”

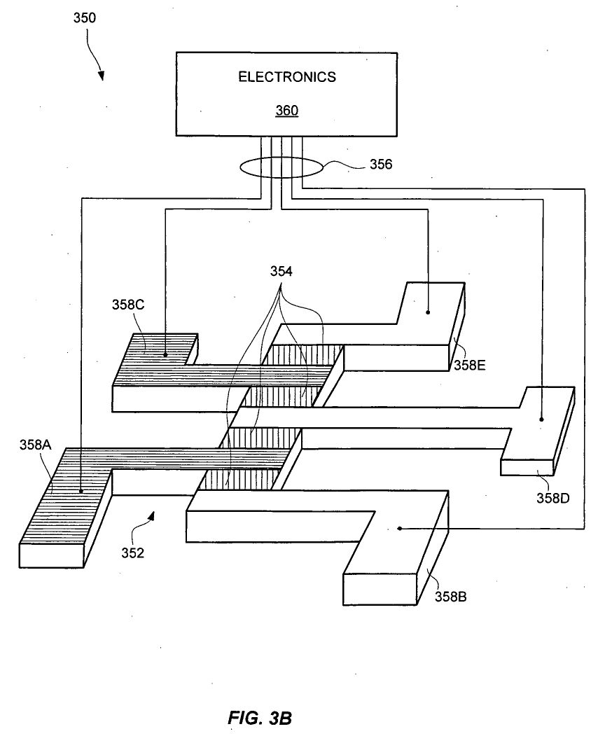

To increase confidence of detection, to add detection redundancy, to exploit spatial characteristics of illumination, and/or to provide other features as a matter of design choice (such as to provide imaging functionality), additional active areas may be incorporated into detector 104, such as shown in FIG. 3A. In FIG. 3A, an optical sensor 300 has a detector 302 with four active areas 304, two input connectivity electrodes 306, and five output connectivity electrodes 308. A current source 310 powers sensor 300 through electrical connections 312 to outer electrodes 306. The voltage drop across each active area 304 is measured by electronics 314 (e.g., an observation instrument 34, FIG. 1), which connects to output electrodes 308 through electrical connections 316 as shown. A semiconducting material 318 separates electrodes 306 from electrodes 308 so that only characteristics of active areas 304 are measured by electronics 306 (for example, semiconducting material 318 comprises the same photoconductive substrate forming active areas 304, similar in function to areas 124, 126 of FIG. 1). With an optical sensor 300 such as shown, each active area 304 may be used to detect an individual speckle such as described in connection with FIG. 2, providing high confidence in actual detection. Signals from active areas 304 may be averaged to increase the signal-to-noise.

Although four active areas 304 are shown in FIG. 3A, it should be apparent that additional or fewer active areas 304 may be incorporated into detector 302 as a matter of design choice.

It should also be clear from FIG. 3A that the configuration of active areas 304 may also be chosen to detect an interference pattern with a known (or expected) spacing between constructive and destructive fringes, such that at least one active area 304 is assured to fit within one spatial period of the pattern. By including multiple active areas 304, the requirements for optical alignment of the system that generates the interference pattern are less stringent, since any one of areas 304 may be used to detect intensity changes in the pattern.

In one embodiment, electronics 314 includes a controller (or computer) that also controls modulation of source 310 (e.g., through a control line 320). By modulating injected current or applied voltage to detector 302, selective amplification of the output of sensor 300 at the modulation frequency may be employed to assist in reducing noise. Electronics 314 may also monitor signals of source 310 through control line 320, as a matter of design choice.

A prototype of detector 302 was fabricated in semi-insulating GaAs. Prototype detector 302 was fabricated by etching bulk material away from an underlying substrate (e.g., substrate 16, FIG. 1). Electrodes 306, 308 were deposited onto detector 302 to form four collinear active regions 304 of dimensions 40×100 μm (for dimensions wd). The driving current from source 310 was approximately two microamperes.

### Experiment 1

The prototype detector 302 was also tested experimentally, by mounting prototype detector 302 within in a dual-inline-package header that connected to electronics 314. Electronics 314 (in this experimental example) amplified the potential difference across each active region 304 and then summed the positive signals from all active regions 304. In order to demonstrate remote measurement of vibrations, an argon laser beam of wavelength λ=488 nm was slightly focused upon a white piece of paper, mounted taut in front of a high-frequency loudspeaker, to a spot size of about D=0.6 mm diameter. The surface normal to the paper was arranged to form 45-degree angles with both the laser beam and a surface normal of detector 302. The laser beam propagated at 90 degrees with respect to the surface normal of detector 302, much like the configuration shown in FIG. 2 (with the paper forming surface 202, and the experimental prototype detector 302 positioned at detector 104 in FIG. 2). The distance from the illuminated spot to detector 302 was approximately L=5 cm. Using

$$d = 1.2 \frac{λ L}{D}$$

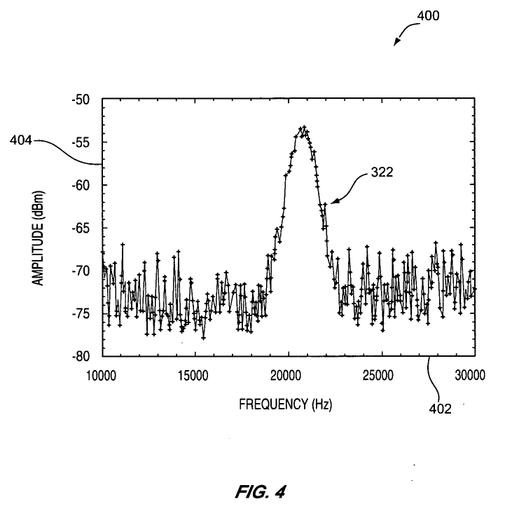

as an estimate for the average size of a speckle gives an approximate speckle size d≈50 μm, comparable to the dimensions of the prototype sensing element 304 (40×100 μm). Application of a sinusoidal driving voltage to the loudspeaker caused vibrations of the paper, resulting in lateral and cyclical displacement of the speckle pattern on detector 302 (e.g., back and forth motion 36 over detector 104, FIG. 1). This in turn caused cyclical variations in sensed voltage from prototype detector 302. Using a spectrum analyzer as electronics 314, the voltage signal at a dominant frequency 322 was clearly visible, as shown in graph 400, FIG. 4 (x-axis 402 shows frequency while y-axis 404 shows signal amplitude from prototype detector 302). Dominant frequency 322, which is 20 kHz, is borderline ultrasonic. In this case, vibrations of the whole object (paper) were detected, as opposed to detecting ultrasonic waves in a solid. Different experiments were performed to prove that prototype detector 302 works for ultrasonic frequencies.

### Experiment 2

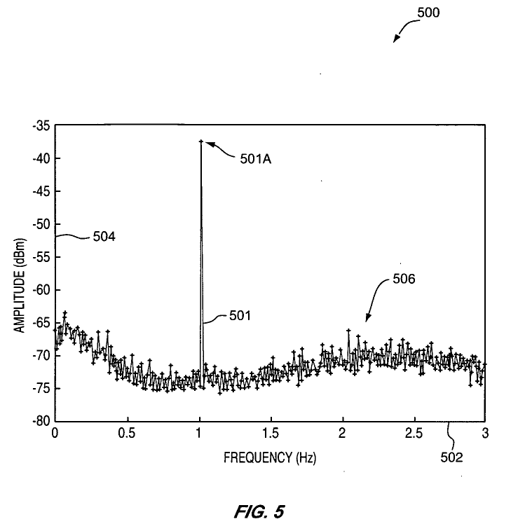

Another experiment was conducted with prototype detector 302. A LiNbO3 electro-optic modulator was placed between a polarizer-analyzer pair; the input polarizer's transmission axis was oriented so as to ensure that light entering the modulator has polarization components along both optical axes. The electrodes of the modulator were not aligned parallel to the principal optical axes of the crystal, so that an applied voltage has different effects on the refractive indices along both axes (which have different electro-optical coefficients). A relative phase difference between the two polarization components is therefore induced, and application of a periodically varying voltage leads to a periodically varying amplitude past the analyzer. Under illumination by a helium-neon laser of wavelength λ=632.8 nm, a clear output signal was observed on the spectrum analyzer for a sinusoidal voltage of frequency 1 MHz applied to the electro-optic modulator, with an average incident intensity of 0.15 mW/cm2 and an intensity modulation depth of m=0.6. The resulting frequency dominant output signal 501 is shown in graph 500 of FIG. 5. In graph 500, x-axis 502 shows frequency while y-axis 504 shows signal amplitude from prototype detector 302. The peak 501A of signal 501 corresponded to the modulation frequency of 1 MHz and is clearly visible, rising about 30 dB above the noise floor 506. This ratio may be improved further, for example, by suppressing the slight gain peaking of the amplifying circuit to achieve a flat frequency response.

Other experiments were performed at frequencies important in ultrasonic testing, from hundreds of kilohertz up to 2 MHz, to determine the sensitivity of the prototype detector 302. At 1 MHz, reducing the modulation depth to m=0.2 reduced the observed peak to −50 dBm, and a further reduction to m=0.05 led to a further decrease to −60 dBm. Accordingly, even for these lower modulation depths, the prototype optical sensor 300 successfully produced a clear output signal, rising 15 to 25 dB above the noise floor.

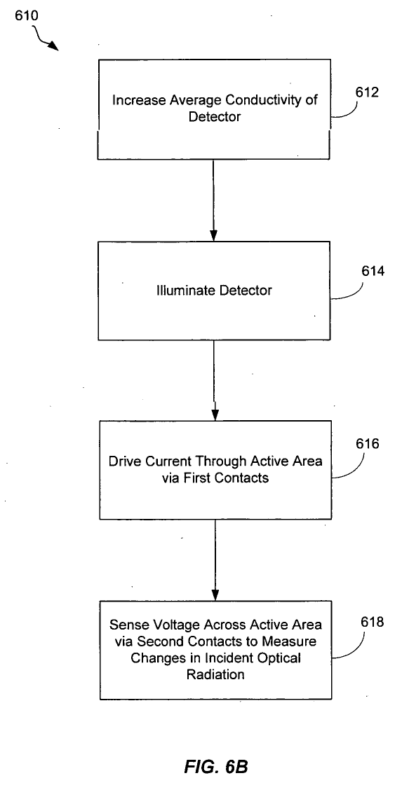

Although electrodes and active areas in FIG. 1 and FIG. 3A are configured in a collinear fashion, this is not required. For example, alternative contact configurations 700, 701 are shown in FIG. 7 and FIG. 7A, respectively. In FIGS. 7 and 7A, the photosensitive active area is denoted as A, current is injected through electrodes B and D, and voltage is measured across monitoring electrodes C and E. Electrodes B, C, D, E are then electrically connected as shown in FIG. 1. That is, consider active area 108 positioned at A in FIG. 7, electrodes 110, 116 positioned at B, C, respectively, and electrodes 114, 116 positioned at D, E, respectively. By injecting current through electrodes 24, 30 and by sensing voltage across electrodes 114, 116, changes of incident optical radiation are detected through active area 108 at position A. The material or connectivity between elements A, B, C, D, E should permit current flow from electrode B to D, and through area A, and also permit measurement of the voltage drop across element A. In one configuration, this material comprises the same photoconductive substrate forming area A (such as in FIG. 1). In one embodiment, trenches (not shown) may be formed (e.g., by etching) between B,C,D,E to ensure that current flows only through active region A and not directly between electrodes B,C,D,E. Other techniques may be used to provide like function, for example disposing a resistive, insulating material between electrodes B,C,D,E and active area A. Those skilled in the art appreciate that active area A may comprise multiple active areas, such as areas 304 of FIG. 3A.

There is also no requirement that all electrodes B, C, D, E be in the same plane. In one example, it may be preferable for manufacturing, for sensitivity, and/or for 2D or 3D detector arrays, to have sensing electrodes C, E and/or injecting electrodes B, D in one or more planes that are above and below the plane of active area A. By analogy, electrodes 306, 308 of detector 302, FIG. 3A, may also be positioned in different planes or locations, as a matter of design choice. Moreover, active areas such as area A or areas 304 (FIG. 3A) may also be positioned to form, for example, two-dimensional or three-dimensional detection arrays, as a matter of design choice.

In one embodiment, one or more epitaxial thin films may be grown on a substrate for the active areas (e.g., areas 304, FIG. 3A) and/or the electrodes (e.g., electrodes 306, 308, FIG. 3A). Epitaxial thin films may for example help increase optical absorption and/or keep carriers from diffusing into the substrate. Certain materials can be manufactured only in thin film form, such as InGaAs. By tailoring these thin films onto the active areas, a detector (e.g., detector 302) may also preferentially detect certain wavelengths or wavebands.

FIG. 3B shows a system 350 for determining changes in incident optical radiation, for example at high frequencies. System 350 is for example an optical sensor 350 including a detector 352 with four active areas 354, five output connectivity electrodes 358A-E and electronics 360, which are for example an observation instrument 360. Observation instrument 360 connects to output electrodes 358A-E through electrical connections 356, as shown. Rather than requiring asymmetrical illumination, active areas 354 for example provide asymmetrical conductivity, and may thus be used to detect changes in incident optical radiation without an external current injection source. Output electrodes 358A and 358C are for example doped opaque contacts, while electrodes 358B, 358D and 358E are opaque contacts that are not doped. A space-charge region may build up at opaque contacts 358A-E at a border between the shadowed and illuminated volumes. Due to asymmetrical conductivity of active areas 354, a charge state of the two space-charge regions will be different, so that a transient voltage across one or more active regions 354 may be observed. Detector 352 may therefore be used to detect changes in incident intensity without an externally supplied current or bias, thus facilitating detection in situations where extremely low power consumption is required, for example, in space satellites or oceanic buoys or instrumentation.

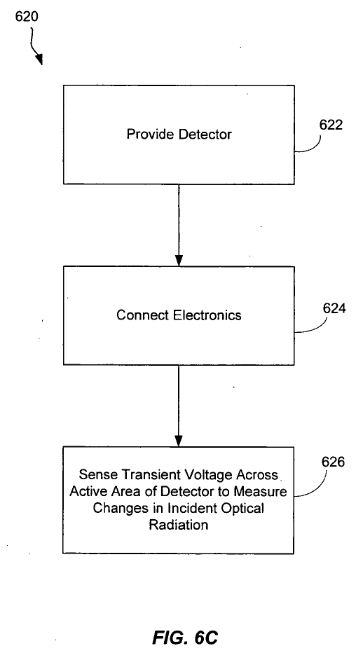

FIG. 8 shows an illustrative illumination arrangement 800 using a multimode optical fiber 802 to monitor a surface 804 with a detector 805 (e.g., detector 104 of FIG. 1, detector 302 of FIG. 3A, or detector A of FIG. 7, 7A). Optical radiation 806 is generated by a laser or LED 808; radiation 806 enters one arm 810A of multimode fiber power splitter 810, which couples to multimode mode fiber 802 through a coupler or splice 812. An end 814 of fiber 802 is placed a small distance d away from the rough surface area of surface 804 to be monitored. Optical radiation 806 that reflects from surface 804 will exhibit time-varying changes if surface 804 vibrates, if fiber 802 moves across surface 804, or if distance d changes (e.g., through tilt or movement of surface 804). This reflected radiation 806 is also collected by multimode fiber 802 through end 814, and interferes with optical radiation 806 that reflects from the air-glass interface at fiber end 814. The two interfering optical signals mix within multimode fiber 802 such that some of this mixed signal 816 emits from a fiber end 818 of another arm 810B of splitter 810, for detection by detector 805. The multimode interference pattern that illuminates detector 805 is time-varying in accordance with the movement of surface 804 (or end 814 or d). The use of fiber 802, 810 enables the measurement to reach surface 804 hidden from view, for example if surface 804 corresponds to a surface of a tooth. It also provides an opportunity to capture a large fraction of light scattered from surface 804 without the use of bulky optics. The function of fiber power splitter 810 may be implemented with classical non-fiber optics (“bulk optics”) as a matter of design choice. Multimode fiber 802 may be replaced with a single mode fiber in certain applications. It is thus apparent that the geometry shown in FIG. 8 may be generalized to an array. That is, an array of fibers 802 may be used to illuminate surface 804; in such a case, the optical sensor utilizes an array of detectors 805 (e.g., detector 302 with an array of elements 304, FIG. 3A) designed to spatially match the fiber array (alternatively, an array of optical sensors, each with one or more detectors 805, may be employed wherein the detectors again spatially match to the array of fibers, to provide like detection from the array of fibers).

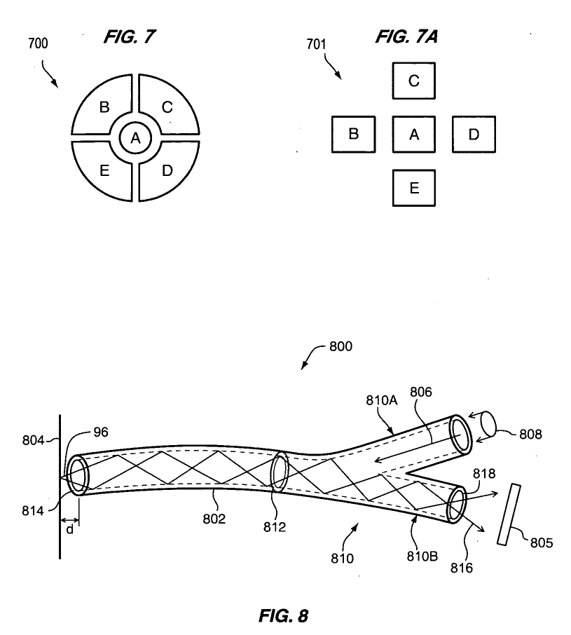

FIG. 9 shows one multimode fiber optic system 900, which includes an optical sensor 902 (e.g., sensor 102 of FIG. 1, or sensor 300, FIG. 3A), a laser or LED 904, and a multimode optical fiber 906. Sensor operates to detect perturbations of fiber 906—for example caused by a weight 908 lying on fiber 906—by detecting changes in optical radiation 905 from multimode fiber 906. In particular, an end 906A of fiber 906 is illuminated by laser or LED 904. A pair of fiber holders 910, 912 illustratively hold fiber 906 while weight 908 perturbs fiber 906; the perturbation changes the multimode interference pattern within fiber 906 that illuminates optical sensor 902 with radiation 905. The varying pattern thus enables sensing of the presence of weight 908.

It should be apparent that sensor 902 similarly works for other causes of fiber perturbation—such as pressure, temperature, magnetic field, electric field and/or the presence of chemicals—in place of weight 908. For example, when fiber 906 is in the configuration of a coil of fiber, placement of a human hand adjacent to fiber 906 (and not necessarily in contact with fiber 906) causes changes in the multimode pattern, which in turn is detected by optical sensor 902. It is thus apparent that the single laser or LED 904 and fiber 906 may comprise an array of lasers or LEDs 904, matched to an array of fibers 906, matched to optical sensor 902 configured as an array (e.g., with a detector 302 employing an array of active areas 304, or an array of sensors 300, or with an array of sensors 902, each with one or more active areas).

It should also be apparent (from reading this disclosure) that optical sensor 902 can be used to sense output of fiber 906, resulting from input laser or LED 904, even when there is no source of perturbation (e.g., weight 908), such as within a communication system. A particularly useful configuration for optical sensor 902 is when it is employed or configured as a two-dimensional or three dimensional array, with fiber 906 replaced by a matching array of fibers, and LEDs 904 being replaced by an array of lasers or LED's. The optical sensor 902 in this configuration spatially matches the array of fibers and is more robust, for example, than the photodiode arrays used today in the prior art.

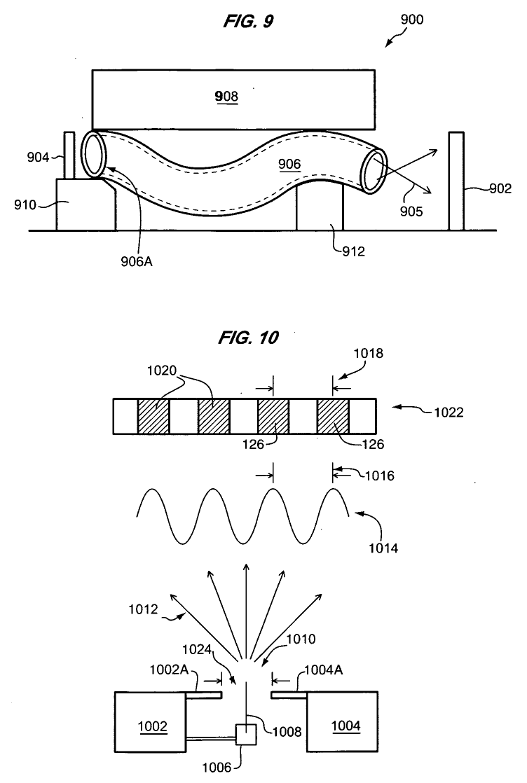

Certain of the detectors described herein may function as a spatial filter, such as illustrated and discussed now in connection with FIG. 10. When the fringe spacing of an interference or diffraction pattern matches the detector spacing in the array, a large signal from each element results for certain spatial frequencies of the pattern (other frequencies may not be detected, for example frequencies with constructive and destructive parts of the pattern within a single active area). This selective frequency detection can be used to align two objects. If the objects are designed to form an aperture of a certain width when correctly aligned, then a light source can be placed behind this aperture and a detector array sensitive to the appropriate spatial frequencies can be placed in front of the aperture. As the objects are brought closer together, the sensor output increases until an optimal position is achieved. Because the spatial frequency of a diffraction pattern is very sensitive to aperture size, precise alignments are possible. An interferometer may be employed to achieve the same effect. These methods are for example useful in the alignment of masks in photolithography.

FIG. 10 shows an illustrative example of these methods, to enable precise alignment of two objects 1002 and 1004. A laser 1006 generates a laser beam 1008 that illuminates a small gap 1010. The interaction between laser beam 1008 and gap 1010 generates diffracted light 1012 that forms a diffraction pattern 1014 with distinct spatial pattern 1016. When gap 1010 has just the right size, spatial pattern 1016 matches the spacing 1018 between active areas 1020 of a detector 1022 (e.g., detector 104 of FIG. 1 or optical sensor 300 of FIG. 3A), then a large signal may result (confirming the desired gap size). Illustratively, object 1002 has an attached knife-edge 1002A; laser 1006 may also attach to object 1002, if desired, while it emits beam 1008. Object 1004 also illustratively has an attached knife-edge 1004A. As object 1002 is brought closer to object 1004, the two knife-edges 1002A and 1004A form aperture 1024 (e.g., gap 1010) of a particular width. As noted, when the width is small enough, laser beam 1008 diffracts past aperture 1024, resulting in diffraction pattern 1014 characterized by fringe spacing 1016 (which depends on the aperture width and, thereby, on the relative spacing between objects 1002 and 1004). Pattern 1014 is incident upon detector array 150, designed such that spacing 1018 matches fringe spacing 1016 under correct alignment conditions. Identical output from all active areas 1020 indicates proper alignment. Similarly, since detector 1022 is detecting relative motion between objects 1002, 1004, the output from detector 1022 may further indicate tracking and/or an angular relationship (and not just alignment) between objects 1002, 1004.

In an alternative arrangement, diffraction pattern 1014 may be produced by interference rather than through single-slit diffraction of gap 1010. That is, objects 1002, 1004 may be formed as part of an interferometer to generate a similar pattern 1014, which can also be detected by detector 1022 (to determine alignment, angular positions and/or tracking of object 1002 relative to object 1004).

The processing of signals from individual active regions 1020 by electronics (e.g., electronics 314, FIG. 3A) may occur through one of several exemplary techniques. For example, one technique is to rectify and sum individual contributions from each active area 1020. Summing contributions of positive and negative polarity separately, and then subtracting one from the other, further increases the signal and reduces common-mode noise. In another example, the largest of all signals from an area 1020 is selected and monitored. In yet another example, individual contributions from areas 1020 may be digitized, to allow extraction of the largest signal and to reduce noise through oversampling on a computer.

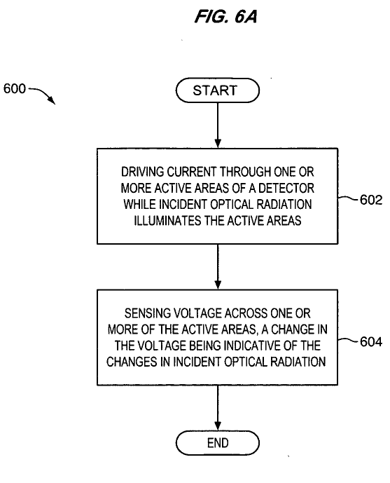

FIG. 6A shows one process 600 for detecting changes in incident optical radiation. In step 602, current is driven through one or more active areas of a detector while the incident optical radiation illuminates the active areas. Step 602 is for example performed by source 120, FIG. 1 under control of electronics 314. Step 602 does not require constant illumination of the active areas by incident optical radiation, but may for example include motion of incident optical radiation over detector 104 (such as when speckle passes over detector 104, FIG. 1). In step 604, voltage is sensed across one or more of the active areas, a change in the voltage being indicative of the changes in incident optical radiation. Step 604 is for example performed by electronics 314, FIG. 3A. Steps 602, 604 may occur substantially at the same time.

FIG. 6B illustrates a method 610 for detecting changes in incident optical radiation at high frequency. In one embodiment, high-frequency operation is achieved by decreasing the dielectric relaxation time must be decreased, which implies an increase in average conductivity. Accordingly, in step 612, a detector having increased average conductivity is provided. Average conductivity may be increased by increasing one or both of average photoconductivity and average dark conductivity. Average photoconductivity is for example increased by increasing a level of illumination upon the detector, by reducing detector dimensions such that the electrode width, e.g., electrical contacts 110, 112, 114, 116, FIG. 1, is comparable to the diffusion length of a detector material, e.g., material of detector 104, or by providing transparent electrical contacts 110, 112, 114, 116. Average dark conductivity is for example increased by fabricating detector 104 from one or more materials with a larger dark carrier concentration, and/or one or more materials having a carrier lifetime that is longer than the dielectric relaxation time. Additionally or optionally, dark conductivity of detector 104 is increased by selectively doping shadowed regions underneath electrical contacts 110, 112, 114, 116.

In step 614, current is driven through active areas via a first set of contacts, for example outer electrodes 110, 116. Voltage is then sensed across an active area, such as active area 108, by a second set of electrical contacts, such as electrodes 112, 114. Changes in voltage for example indicate changes in incident optical radiation.

FIG. 6C illustrates another method of measuring changes in incident optical radiation at high frequencies. Method 620 provides for low-power measurement of symmetrical illumination using an asymmetrically conductive detector with a set of opaque contacts, for example as illustrated in FIG. 3B. Such a detector is provided, in step 622. A space-charge region may build up at opaque contacts (e.g., contacts 304) at the border between the shadowed and illuminated volumes. Due to the asymmetry, the charge state of the two space-charge regions will be different, so that a transient voltage across the active region may be observed. Hence, electronics are connected to the opaque contacts, at step 614, and a transient voltage across at least one active area of the detector is measured, in step 616. The detector may be used to detect changes in incident intensity without an externally supplied current or bias, and may therefore be useful where extremely low power consumption is required, for example, in space satellites, or oceanic buoys or instrumentation.

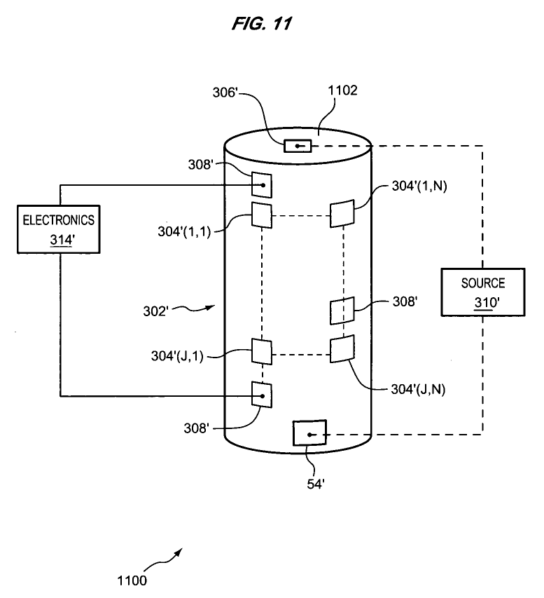

FIG. 11 shows one three-dimensional optical sensor 1100 employing an optical radiation detector 302′, to illustrate how an array of active areas 304′ may be constructed on a photoconductive surface 1102 (on a cylindrical substrate, as shown). Active areas 304′ are formed by placement of an array of sensing electrodes 308′ onto photoconductive surface 1102—for example to provide like function to electrodes 308 and active areas 304 of FIG. 3A (only three electrodes 308′ are shown for purposes of illustration). Electronics 314′ (e.g., an observation instrument) connects to sensing electrodes 308′ to determine voltage drop across active areas 304′. Injecting electrodes 306′ are also disposed with photoconductive surface 1102 so that current flows across each active area 304′ (e.g., through connection to a source 310′, e.g., a direct current source), such as injecting electrodes 306 and active areas 304 of FIG. 3A. Only two electrodes 306′ are shown for purposes of illustration; though more electrodes 306′ may be included, if needed or desired. Photoconductive surface 1102 in FIG. 11 is arranged on the outside of the cylinder substrate, though other shapes may be formed as a matter of design choice. The array of active areas 304′ is illustratively shown as active areas 304′(1,1) . . . 304′(J,N), where J, N are integers corresponding to the desired number of detecting elements for detector 302′.

Since certain changes may be made in the above methods, sensors and systems without departing from the scope hereof, it is intended that all matter contained in the above description or shown in the accompanying drawings be interpreted as illustrative and not in a limiting sense. For example, although the above description often discusses surface motion as the cause for change of incident optical radiation, it should be clear from reading the above disclosure that moving the detector through a stationary illumination pattern may also be employed to determine changes in incident optical radiation, to determine the motion of the detector relative to the means of generating the stationary optical pattern.

It is also to be understood that the following claims are to cover all generic and specific features described herein, and all statements of the scope which, as a matter of language, might be said to fall there between.

What is claimed is:

1. A system for detecting changes in incident optical radiation at high frequencies, comprising:
a detector having one or more asymmetrically conductive active areas formed of relaxation semiconductor material;
at least two electrical contacts configured with the detector and positioned with an active area therebetween; and
electronics connected to the electrical contacts, for sensing a transient voltage across the active area, the transient voltage being indicative of the changes in incident optical radiation.

2. The system of claim 1, wherein asymmetrical conductivity is provided by doping a first of the at least two electrical contacts, the second electrical contact being un-doped.

3. A method for detecting changes in incident optical radiation at high frequencies, comprising:
providing a detector having:
one or more asymmetrically conductive active areas formed of relaxation semiconductor material, and
at least two electrical contacts on opposite sides of an active area;
connecting electronics to the at least two electrical contacts;
exposing the detector to illumination; and
sensing a transient voltage across the active area, the transient voltage being indicative of the changes in incident optical radiation.

4. The method of claim 3, further comprising determining motion of an object surface that causes the changes in incident optical radiation.

5. The method of claim 4, wherein determining the motion of the object surface comprises:
illuminating the surface with a laser having a wavelength that is smaller than defined geometric features of the surface, such that moving speckle indicative of surface motion illuminates the asymmetrically conductive active areas; and
wherein surface motion is determined by sensing transient voltage across one or more of the active areas, with the electrical contacts. 1

6. The method of claim 4, wherein the surface motion comprising surface displacement.

7. The method of claim 4, wherein determining the motion of the object surface comprises generating an interference pattern that varies with surface motion and detecting the interference pattern by:
sensing the transient voltage across one or more of the active areas to detect the surface motion.

8. The method of claim 3, the step of sensing comprising determining transient variation in the voltage in one or both of a time domain and a frequency domain.

9. The method of claim 3, the step of sensing comprising determining periodic variation in the voltage in one or both of a time domain and a frequency domain.

10. The method of claim 9, the step of sensing comprising determining voltage signals in a time-domain.

11. The method of claim 9, the step of sensing comprising determining voltage signals in a frequency-domain.

12. The method of claim 3, the step of sensing voltage comprising utilizing an observation instrument.

13. The method of claim 12, the step of sensing voltage comprising determining cyclical variations in the voltage to isolate one or more frequencies with signal strength above a noise floor.

14. The method of claim 3, wherein the incident optical radiation comprises an interference or diffraction pattern dependent upon a distance between two objects, further comprising the steps of:
sensing changes in the interference or diffraction pattern to achieve optimal alignment between the objects by:
sensing transient voltage across the active areas while the interference or diffraction pattern illuminates the active areas, wherein the change in the voltage indicates a change in the distance between the objects, and
further comprising the steps of:
assessing relative position between the objects, and
optimally aligning the objects, according to the changes in the interference or diffraction pattern.

15. The method of claim 14, wherein the step of assessing relative position comprises assessing relative angles between the two objects, and wherein the change in the voltage indicates a change in the angular relationship between the objects.

16. The method of claim 3, comprising increasing the average conductivity of the detector.

17. The method of claim 16, wherein increasing the average conductivity of the detector comprises increasing one or both of dark conductivity and average photoconductivity.

18. The method of claim 17, wherein increasing the dark conductivity of the detector comprises one or more of:
forming the detector from a material having a large dark carrier concentration;
forming the detector from a material having a carrier lifetime that is longer than the dielectric relaxation time of the material; and
selectively doping shadowed regions under the electrical contacts.

19. The method of claim 17, wherein increasing the average photoconductivity of the detector comprises one or more of:
increasing an intensity of the incident optical radiation.
reducing detector dimensions, such that a width of the electrical contact is comparable to the diffusion length of a detector material; and
utilizing transparent first and second sets of electrical contacts.

20. A system for detecting changes in a spatially uniform or non-uniform optical intensity distribution incident on the system, comprising:
one or more volumes of photoconductive material;
at least one doped electrical contact and at least one un-doped electrical contact;
one or more conductive paths connecting the electrical contacts to the volumes of photoconductive material so as to form a series circuit, with the volumes of photoconductive material located between the electrical contacts; and
electronics for determining a transient voltage across one or more of the volumes of photoconductive materials, a change in voltage being indicative of a change in the optical intensity distribution.

21. The system of claim 20, further comprising comparing the time rate of change of the voltage across at least two areas of photoconductive material, a difference being indicative of spatial characteristics of the spatially uniform optical intensity distribution.
